(19) United States
(12) Patent Application Publication
(10) Pub. No.: US 2024/0144920 A1
(43) Pub. Date: May 2, 2024

(54) METHOD AND APPARATUS FOR AUTOMATIC INTENT DETECTION IN CUSTOMER SERVICE ENVIRONMENTS

(71) Applicant: Uniphore Technologies, Inc., Palo Alto, CA (US)

(72) Inventors: Ayeleth ZARROUK, Harzliyya (IL); Asaf WEXLER, Tel Aviv (IL)

(21) Appl. No.: 17/978,203

(22) Filed: Oct. 31, 2022

(51) Int. Cl. G10L 15/18; G06F 40/30; G10L 15/22; G10L 15/30

(52) U.S. Cl. CPC G10L 15/1815; G06F 40/30; G10L 15/22; G10L 15/30; H04M 3/51

(57) ABSTRACT

Method and apparatus for intent detection in customer service environments includes a processor, and a memory storing instructions that, when executed by the processor, configure the apparatus to perform a method. The method includes processing an input includes a message of a conversation by multiple artificial intelligence/machine learning (AI/ML) models. The message includes a transcript or a summary of at least a part of the conversation. Each of the multiple models is configured to generate, based on the input, an output including an intent of the conversation. A single output corresponding to the conversation is determined based on the multiple outputs, one from each of the multiple models.

### FIELD

The present invention relates generally to customer service or call center computing and management systems, and particularly to automatic intent detection in customer service environments.

### BACKGROUND

Several businesses need to provide support to its customers, which is provided by a customer service center (also known as a “call center”) operated by or on behalf of the businesses. Customers of a business place a call to or initiate a chat with the call center of the business, where customer service agents address and resolve customer issues, to address the customer's queries, requests, issues and the like. The agent uses a computerized management system used for managing and processing interactions or conversations (e.g., calls, chats and the like) between the agent and the customer. The agent is expected to understand the customer's issues, provide appropriate resolution, and achieve customer satisfaction.

Call management systems may help with an agent's workload, complement or supplement an agent's functions, manage agent's performance, or manage customer satisfaction, and in general, such call management systems can benefit from understanding the content of a conversation, such as entities mentioned, intent of the customer, among other information. Such systems may rely on automated identification of intent and/or entities of the customer (e.g., in a call or a chat) of the call center. Conventional systems, which typically rely on an artificial intelligence and/or machine learning (AI/ML) model, for example, to classify the call or a chat into an intent classification, often suffer from low accuracy, and need extensive training before deployment is suitable for commercial environments.

Accordingly, there exists a need in the art for improved method and apparatus for automatic intent detection in customer service environments.

### SUMMARY

The present invention provides a method and an apparatus for automatic intent detection in customer service environments, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an apparatus for automatic intent detection in customer service environments, in accordance with one embodiment.

FIG. 2 illustrates a method for automatic intent detection in customer service environments performed by the apparatus of FIG. 1, in accordance with one embodiment.

### DETAILED DESCRIPTION

Embodiments of the present invention relate to intent detection and entity recognition in customer service environments. Systems based on a single model suffer from low accuracy in determining the intent or entities in conversations, such as chats, audio calls, video calls, for example, between a customer and an agent, hereinafter referred to as a “call” or “conversation,” except where apparent from the context otherwise. Accuracy is sensitive to several factors, such as the quality and quantity of data on which one or more models are trained, data available as input based on which intent and/or entity is determined, for example, sufficiency of data, quality of data distribution, and the like. Embodiments of the present invention utilize an ensemble of multiple models arranged to determine an intent of a call and/or entities from the call. The multiple models are configured to process a message from the call in a parallel configuration. The message includes, for example, a transcript or a portion thereof, which may be processed, for example, with natural language processing (NLP), or a full or partial summary of the call. The outputs from each of the multiple models are used to determine a single output corresponding to the intent of the call and/or the entity(ies) mentioned in the call.

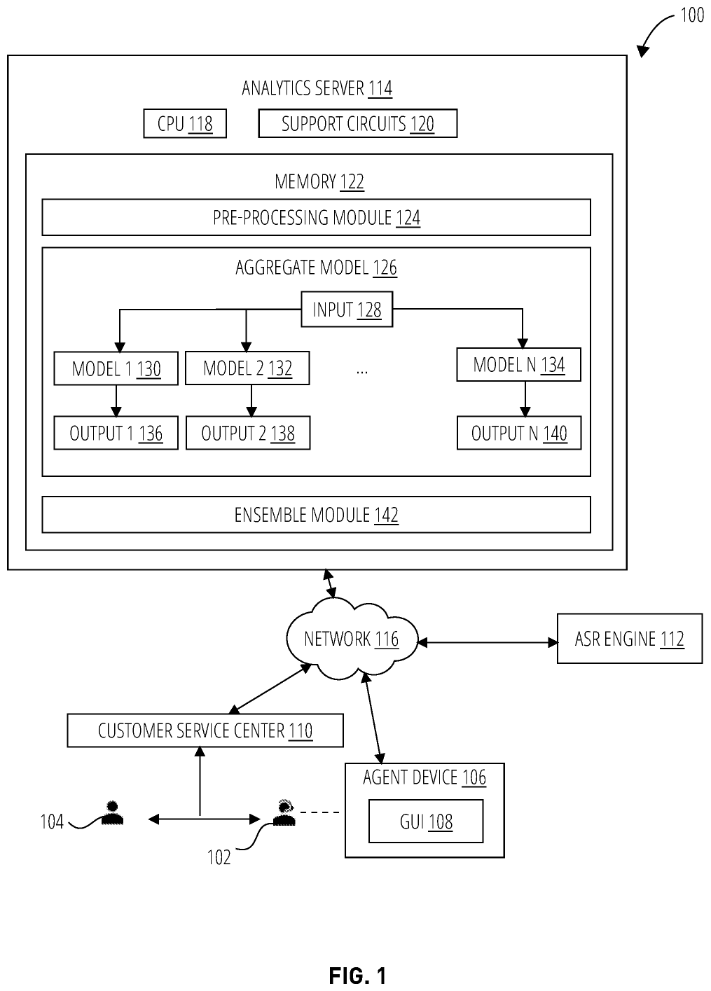

FIG. 1 illustrates an apparatus 100 for improved intent detection and entity recognition in customer service environments, in accordance with one embodiment. The apparatus 100 includes a customer service center 110, an ASR Engine 112, and an analytics server 114, each communicably coupled via a network 116.

The customer service center 110 has an agent 102 interacting or conversing with a customer 104. The conversations between the agent 102 and the customer 104 include, for example, a call audio, a chat text, or other forms, such as a multimedia file. In some embodiments, the conversations (chats, audio or multimedia data) are stored in a repository (not shown) for later retrieval, for example, for being sent to the analytics server 114 and/or the ASR Engine 112, or another processing element. In some embodiments, the customer service center 110 streams a live conversation between the agent 102 and the customer 104 to the analytics server 114 and/or the ASR Engine 112.

The agent 102 accesses an agent device 106 having a graphical user interface (GUI) 108. In some embodiments, the agent 102 uses the GUI 108 for providing inputs and viewing outputs. In some embodiments, the GUI 108 is capable of displaying an output, for example, intent, entities, summary of the call, or other information regarding the call to the agent 102, and receiving one or more inputs from the agent 102, for example, while the call is active. In some embodiments, the GUI 108 is communicably coupled to the analytics server 114 via the network 116, while in other embodiments, the GUI 108 is a part of the customer service center 110, and communicably coupled to the analytics server 114 via the communication infrastructure used by the customer service center 110.

The ASR Engine 112 is any of the several commercially available or otherwise well-known ASR Engines, as generally known in the art, providing ASR as a service from a cloud-based server, a proprietary ASR Engine, or an ASR Engine which can be developed using known techniques. ASR Engines are capable of transcribing speech data (spoken words) to corresponding text data (transcribed text, text words or tokens) using automatic speech recognition (ASR) techniques, as generally known in the art, and include a timestamp for some or each uttered words or token(s). In some embodiments, the ASR Engine 112 is implemented on the analytics server 114 or is co-located with the analytics server 114, or otherwise, as an on-premises service.

The analytics server 114 includes a CPU 118 communicatively coupled to support circuits 120 and a memory 122. The CPU 118 may be any commercially available processor, microprocessor, microcontroller, and the like. The support circuits 120 comprise well-known circuits that provide functionality to the CPU 118, such as, a user interface, clock circuits, network communications, cache, power supplies, I/O circuits, and the like. The memory 122 is any form of digital storage used for storing data and executable software, which are executable by the CPU 118. Such memory 122 includes, but is not limited to, random access memory, read only memory, disk storage, optical storage, various non-transitory storages known in the art, and the like. The memory 122 includes computer readable instructions corresponding to an operating system (not shown), a pre-processing module 124, an aggregate model 126, and an ensemble module 142.

A message of the conversation is input into the pre-processing module 124. The message is, for example, one or more of a transcript of a part of the conversation (for example, one turn or multiple consecutive turns in the conversation), transcript of the complete conversation, a chunk of the transcript, where the transcript or chunk of the transcript may include NLP tagging, a summary of the conversation, or a summary a part of the conversation. The pre-processing module 124 is configured to decontextualize the message and preprocess the decontextualized message, according to the business' preference. The pre-processing module 124 performs decontextualization by rewriting a message to be interpretable out of context in which the message is originally composed in, while still preserving the meaning of the message, for example, by dereferencing pronouns, adding information, among other techniques as known in the art. The pre-processing module 124 performs preprocessing by removing stop words from a message, analyzing parts of speech, and dependency between words of the message, among others.

The preprocessed message is provided as input 128 to the aggregate model 126, which is configured to generate multiple outputs 136, 138, . . . 140 from the input 128. The aggregate model 126 includes multiple models, for example, model 1 130, model 2 132, . . . model n 134, configured to operate in parallel. Each of the models 130, 132, . . . 134 may be a single model, or an aggregated model, and includes classifiers, predictors or others models as known in the art. One or more of the models 130, 132, . . . 134 may have different capabilities, for example, some model(s) achieve high accuracy with low amount of training data, while some model(s) achieve a high accuracy with a large amount of training data, some models operate faster than others, and some models may require lower processing resources than others. Each of the models 130, 132, . . . 134 is configured or trained to receive the message as input 128, and to output an intent of the conversation and/or one or more entities mentioned in the conversation. In operation, each of the models, model 1 130, model 2 132, . . . model n 134 receives the same input 128, which each model then processes individually, that is, in parallel, to generate an output, for example, output 1 136, output 2 138, . . . output n 140, respectively. Each of the models 130, 132, . . . 134 is trained with data containing inputs corresponding to conversations, similar to the input 128, with known intent and/or entity(ies) for the conversations, using standard training methodology.

The outputs 136, 138, . . . 140 are provided as inputs to the ensemble module 142, which is configured to determine a single output, including an intent of the conversation and/or one or more entities from mentioned in the conversation, from the multiple outputs 136, 138, . . . 140.

In some embodiments, the ensemble module 142 waits to receive the multiple outputs 136, 138, . . . 140 from each of the models 130, 132, . . . 134 of the aggregate model 126, before the ensemble module 142 proceeds to determine a single output from the multiple outputs 136, 138, . . . 140. In some embodiments, the ensemble module 142 waits up to a predefined cutoff time threshold from the time one or more of the models 130, 132, . . . 134 are provided the input 128, after which, the ensemble module 142 proceeds to process the outputs received from the aggregate model 126 (that is, from two or more models 130, 132, . . . 134). For example, if up to the predefined cutoff time, only model 1 130 and model n 134 provide the output 1 136 and output n 140, and the model 2 132 does not provide the output 2 138, the ensemble module 142 proceeds with the output 1 136 and output n 140 as inputs, to determine a single output. In some embodiments, the predefined cutoff time threshold is between about 1 ms to about 1,500 ms, and in some embodiments, the predefined cutoff time threshold is between about 800 ms to about 1,200 ms.

In some embodiments, the ensemble module 142 is configured to select one output from the multiple outputs, for example, two or more of the outputs 136, 138, . . . 140. In some embodiments, two or more outputs are ranked based on a confidence measure, for example, a qualitative measure of the output, such as certain, suggested or lower than suggested according to the model that generated the output, and the output with the highest confidence measure is determined as the single output. For example, if one of the multiple outputs has a confidence score of 80%, which deems the output confidence measure as certain, while others have a confidence scores of 85% but the output confidence measure is deemed to be suggested, the output with the confidence measure of certain is selected as the single determined output. In some embodiments, the multiple outputs are polled, and the outputs with a value having a majority is determined as the single output. For example, if out of 10 outputs (produced by 10 models), 6 outputs have the same value of intent or entity(ies), such as “insurance claim” as the intent, or “Oct. 10, 2022” as “incident date” entity, and 4 have a different value(s), the output value with 6 matching outputs is in majority and is selected as the single determined output. In case multiple groups of outlets have the same values, for example, 4 outputs have a first value, 4 other outputs have a second value, and 2 other outputs have different value(s) than the first and the second values, any technique of conflict resolution may be employed. For example, an average confidence score for the 4 outputs with the first value is compared with the average confidence score for the 4 outputs with the second value, and the higher average value is determined as the single output. In some embodiments, one or more mathematical operations are used to determine the single output. For example, in a conflict scenario, a customer says “Can you please stop calling,” and between two models, a first model classifies the customer speech as “stop calling” intent, and the second model classifies the same customer speech as “call me back” intent, and both the models classifications are rated at “certain” on confidence measure. In such conflict scenarios, we resolve the conflict by selecting the model based on the meaning, which in the example above is the first model. In related scenarios, where two models classify the speech as “stop calling” intent, and one classifies the call as “call me back” intent, and all are rated “certain” on confidence measure, the intent classifications can be combined using the equation x/(x+1), where x is the number of models that returned the same intent with a confidence measure of certain. The formula (x/x+1) is used to boost the score, and then a selection is made based on the scoring algorithm. If both of the conflicting classifiers are based on the meaning of the message, the classification based on the highest score is selected.

In some embodiments, delays may be introduced (or may otherwise occur) in providing the input 128 to one or more models 130, 132, . . . 134. Further, delays may be introduced (or may otherwise occur) after outputs 136, 138, . . . 140 are generated by the one or more of models 130, 132, . . . 134. In some embodiment, no delays are introduced in either providing the input 128 or added to the outputs 136, 138, . . . 140. In some embodiments, the ensemble module 142 processes the multiple outputs 136, 138, . . . 140 without delay, such that the single output is generated from a live conversation in real time or as soon as physically possible.

Each of the outputs includes an intent of the conversation, such as of one of the parties to the conversation, one or more entities mentioned in the conversation, or both the intent and one or more entities. For example, in an agent-customer conversation, the output includes an intent of the customer, one or more entities mentioned by the customer, or both. In some embodiments, intent includes a category of the conversation or the call as defined according to the business' domain, a promise made by an agent, an objection raised by a customer, among others. The single determined output of intent and/or entity(ies) may be sent for display to the agent 102, for example, on the GUI 108, while the call is active. In some embodiments, the single determined output is sent as a part of a summary of the conversation or a call summary.

The network 116 is a communication network, such as any of the several communication networks known in the art, and for example a packet data switching network such as the Internet, a proprietary network, a wireless GSM network, among others. The network 116 is capable of communicating data to and from the customer service center 110, the ASR Engine 112, the analytics server 114 and the GUI 108. In some embodiments, one or more components of the apparatus 100 are communicably coupled directly with another using communication links as known in the art, separate from the network 116.

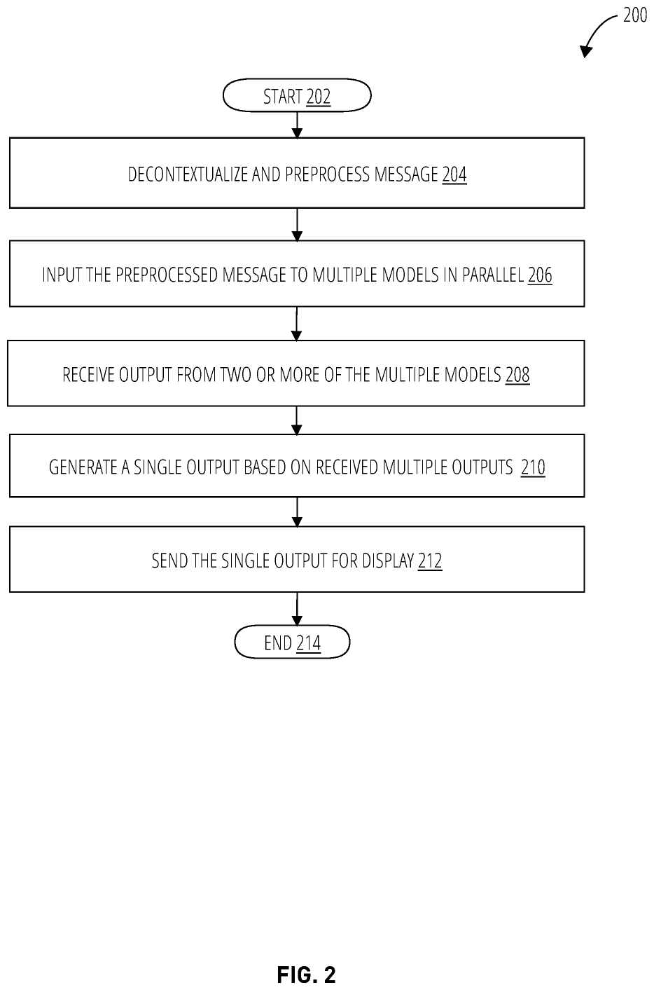

FIG. 2 illustrates a method 200 for intent detection and entity recognition in customer service environments performed by the apparatus 100 of FIG. 1, in accordance with one embodiment. In some embodiments, the method 200 is performed by the analytics server 114.

According to some examples, the method 200 starts at step 202, and proceeds to step 204, at which the method 200 decontextualizes the message and then preprocesses the message according to the business rules. In some embodiments, step 204 is performed by the pre-processing module 124. The method 200 proceeds to step 206, at which the preprocessed message is input to multiple models, for example, the models 130, 132, . . . 134 of the aggregate model 126, in parallel. At step 208, the method 200 receives an output from each of the multiple models, thereby receiving multiple outputs 136, 138, . . . 140 generated by the one or more of models 130, 132, . . . 134, respectively. In some embodiments, the steps 206-208 are performed by the aggregate model 126.

In some embodiments, the method 200 waits to receive the multiple outputs 136, 138, . . . 140 from each of the models 130, 132, . . . 134 of the aggregate model 126 at step 208, before the method 200 proceeds to step 210, at which a single output from the multiple outputs is determined. In some embodiments, the method 200 waits up to a predefined cutoff time threshold from the time one or more of the models 130, 132, . . . 134 are provided the input 128, after which, the method 200 proceeds to step 210, at which two or more outputs received from the aggregate model 126 (from two or more models of the models 130, 132, . . . 134) up to the cutoff time are processed. For example, if up to the predefined cutoff time, only model 1 130 and model n 134 provide the output 1 136 and output n 140, and the model 2 132 does not provide the output 2 138, the ensemble module 142 proceeds with the output 1 136 and output n 140 as inputs, to determine a single output. In some embodiments, the predefined cutoff time threshold is between about 1 ms to about 1,500 ms, and in some embodiments, the predefined cutoff time threshold is between about 800 ms to about 1,200 ms.

At step 210, the method 200 generates a single output based on the multiple outputs 136, 138, . . . 140 received at step 208. In some embodiments, the outputs 136, 138, . . . 140 are provided as inputs at step 208 to the ensemble module 142, which is configured to determine a single output from the multiple outputs 136, 138, . . . 140 at step 210.

In some embodiments, the ensemble module 142 is configured to select one output from the multiple outputs, for example, two or more of the outputs 136, 138, . . . 140. In some embodiments, two or more outputs are ranked based on a confidence measure, for example, a qualitative measure of the output, such as certain, suggested or lower than suggested according to the model that generated the output, and the output with the highest confidence measure is determined as the single output. For example, if one of the multiple outputs has a confidence score of 80%, which deems the output confidence measure as certain, while others have a confidence scores of 85% but the output confidence measure is deemed to be suggested, the output with the confidence measure of certain is selected as the single determined output. In some embodiments, the multiple outputs are polled, and the outputs with a value having a majority is determined as the single output. For example, if out of 10 outputs (produced by 10 models), 6 outputs have the same value of intent or entity(ies), such as “insurance claim” as the intent, or “Oct. 10, 2022” as “incident date” entity, and 4 have a different value(s), the output value with 6 matching outputs is in majority and is selected as the single determined output. In case multiple groups of outlets have the same values, for example, 4 outputs have a first value, 4 other outputs have a second value, and 2 other outputs have different value(s) than the first and the second values, any technique of conflict resolution may be employed. For example, an average confidence score for the 4 outputs with the first value is compared with the average confidence score for the 4 outputs with the second value, and the higher average value is determined as the single output. In some embodiments, one or more mathematical operations are used to determine the single output. For example, in a conflict scenario, a customer says “Can you please stop calling,” and between two models, a first model classifies the customer speech as “stop calling” intent, and the second model classifies the same customer speech as “call me back” intent, and both the models classifications are rated at “certain” on confidence measure. In such conflict scenarios, we resolve the conflict by selecting the model based on the meaning, which in the example above is the first model. In related scenarios, where two models classify the speech as “stop calling” intent, and one classifies the call as “call me back” intent, and all are rated “certain” on confidence measure, the intent classifications can be combined using the equation x/(x+1), where x is the number of models that returned the same intent with a confidence measure of certain. The formula (x/x+1) is used to boost the score, and then a selection is made based on the scoring algorithm. If both of the conflicting classifiers are based on the meaning of the message, the classification based on the highest score is selected.

In some embodiments, delays may be introduced (or may otherwise occur) in providing the input 128 to one or more models 130, 132, . . . 134. Further, delays may be introduced (or may otherwise occur) after outputs 136, 138, . . . 140 are generated by the one or more of models 130, 132, . . . 134. In some embodiment, no delays are introduced in either providing the input 128 or added to the outputs 136, 138, . . . 140. In some embodiments, the ensemble module 142 processes the multiple outputs 136, 138, . . . 140 without delay, such that the single output is generated from a live conversation in real time or as soon as physically possible.

Each of the outputs includes an intent of the conversation, such as of one of the parties to the conversation, one or more entities mentioned in the conversation, or both the intent and one or more entities. For example, in an agent-customer conversation, the output includes an intent of the customer, one or more entities mentioned by the customer, or both. In some embodiments, intent include a category of the conversation, or the call as defined according to the business' domain, a promise made by an agent, an objection raised by a customer, among others.

At step 212, the method 200 sends the single output for display, for example, to a GUI of the agent device 106. In some embodiments, the single determined output of intent and/or entity(ies) may be sent for display to the agent 102, for example, on the GUI 108, while the call is active. Further, in some embodiments, the single determined output is sent as a part of a summary of the conversation or a call summary. In some embodiments, the steps 210-212 are performed by the ensemble module 142.

The method 200 proceeds to step 214, at which the method 200 ends.

Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence. While various techniques discussed herein refer to conversations in a customer service environment, the techniques described herein are not limited to customer service applications. Instead, application of such techniques is contemplated to any conversation that may utilize the disclosed techniques, including single party (monologue) or a multi-party speech. While some specific embodiments have been described, combinations thereof, unless explicitly excluded, are contemplated herein.

While reference is made to a “call,” the term is intended to include, without limitation, chat and other channels of interaction or conversations, for example, a video call with a customer. While intent and entities are referenced herein to elucidate various embodiments, the techniques described therein can be extended to other features. Further, while specific threshold score values have been illustrated above, in some embodiments, other threshold values may be selected. While various specific embodiments have been described, combinations thereof, unless explicitly excluded, are contemplated herein.

While various techniques discussed herein refer to conversations in a customer service environment, the techniques described herein are not limited to customer service applications. Instead, application of such techniques is contemplated to any conversation that may utilize the disclosed techniques, including single party (monologue) or a multi-party speech. While some specific embodiments have been described, combinations thereof, unless explicitly excluded, are contemplated herein.

The methods described herein may be implemented in software, hardware, or a combination thereof, in different embodiments. In addition, the order of steps in methods can be changed, and various elements may be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing platform or a “virtual machine” running on one or more computing platforms). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

I/We claim:

1. A computing apparatus for automatic intent detection, the computing apparatus comprising:
a processor; and
a memory storing instructions that, when executed by the processor, configure the apparatus to:
process an input comprising a message of a conversation by a plurality of artificial intelligence/machine learning (AI/ML) models, each of the plurality of models configured to generate an output comprising an intent of the conversation from the input, the message comprising at least one of a transcript of at least a part of the conversation, or a summary of the at least a part of the conversation;
receive a plurality of outputs, one from each of the plurality of models, each of the plurality of outputs comprising an intent of the conversation; and
determine, from the plurality of outputs, a single output of the conversation.

2. The computing apparatus of claim 1, wherein the determining comprises:
generating, from the plurality of outputs, a plurality of clusters of the outputs, each of the plurality of clusters having the same value of the intent;
identifying the cluster with the highest number of outputs; and
selecting the intent of the identified cluster as the single output.

3. The computing apparatus of claim 1, wherein the determining comprises:
ranking at least two outputs from the plurality of outputs on a confidence measure of each of the plurality of outputs; and
selecting, from the plurality of outputs, the output with the highest confidence measure as the single output.

4. The computing apparatus of claim 1, wherein the receiving comprises waiting for the output from each of the plurality of models.

5. The computing apparatus of claim 1, wherein the receiving comprises waiting for a cutoff time threshold, and wherein-the determining comprises determining the single output from the outputs received within the cutoff time threshold.

6. The computing apparatus of claim 5, wherein the cutoff time threshold is 1,500 ms.

7. A computer-implemented method for automatic intent detection, the method comprising:
processing an input comprising a message of a conversation by a plurality of artificial intelligence/machine learning (AI/ML) models, each of the plurality of models configured to generate an output comprising an intent of the conversation from the input, the message comprising at least one of a transcript of at least a part of the conversation, or a summary of the at least a part of the conversation;
receiving a plurality of outputs, one from each of the plurality of models, each of the plurality of outputs comprising an intent of the conversation; and
determining, from the plurality of outputs, a single output of the conversation.

8. The computer-implemented method of claim 7, wherein the determining comprises:
generating, from the plurality of outputs, a plurality of clusters of the outputs, each of the plurality of clusters having the same value of the intent;
identifying the cluster with the highest number of outputs; and
selecting the intent of the identified cluster as the single output.

9. The computer-implemented method of claim 7, wherein the determining comprises:
ranking at least two outputs from the plurality of outputs on a confidence measure of each of the plurality of outputs; and
selecting, from the plurality of outputs, the output with the highest confidence measure as the single output.

10. The computer-implemented method of claim 7, wherein the receiving comprises waiting for the output from each of the plurality of models.

11. The computer-implemented method of claim 7, wherein the receiving comprises waiting for a cutoff time threshold, and wherein-the determining comprises determining the single output from the outputs received within the cutoff time threshold.

12. The computer-implemented method of claim 11, wherein the predefined cutoff time threshold is 1,500 ms.

13. A non-transitory computer-readable storage medium, the computer-readable storage medium including instructions that when executed by a computer, cause the computer to:
process an input comprising a message of a conversation by a plurality of artificial intelligence/machine learning (AI/ML) models, each of the plurality of models configured to generate an output comprising an intent of the conversation from the input, the message comprising at least one of a transcript of at least a part of the conversation, or a summary of the at least a part of the conversation;
receive a plurality of outputs, one from each of the plurality of models, each of the plurality of outputs comprising an intent of the conversation; and
determine, from the plurality of outputs, a single output of the conversation.

14. The computer-readable storage medium of claim 13, wherein the determining comprises:
generate, from the plurality of outputs, a plurality of clusters of the outputs, each of the plurality of clusters having the same value of the intent;
identify the cluster with the highest number of outputs; and
select the intent of the identified cluster as the single output.

15. The computer-readable storage medium of claim 13, wherein the determining comprises:
rank at least two outputs from the plurality of outputs on a confidence measure of each of the plurality of outputs; and
select, from the plurality of outputs, the output with the highest confidence measure as the single output.

16. The computer-readable storage medium of claim 13, wherein the receiving comprises wait for the output from each of the plurality of models.

17. The computer-readable storage medium of claim 13, wherein the receiving comprises wait for a cutoff time threshold, and wherein-the determining comprises determining the single output from the outputs received within the cutoff time threshold.

18. The computer-readable storage medium of claim 17, wherein the predefined cutoff time threshold is 1,500 ms.
